(19) United States
(12) Patent Application Publication
(10) Pub. No.: US 2025/0044402 A1
(43) Pub. Date: Feb. 6, 2025

(54) Method for the transmission of radio signals by a radar installed in a vehicle, and corresponding device and computer program

(71) Applicant: ECOLE NATIONALE DE L'AVIATION CIVILE (ENAC), TOULOUSE (FR)

(72) Inventor: Sylvain Roudière, TOULOUSE (FR)

(21) Appl. No.: 18/697,243

(22) PCT Filed: Sep. 30, 2022
(86) PCT No.: PCT/EP2022/077291

§ 371 Date: Mar. 29, 2024

(30) Foreign Application Priority Data
Sep. 30, 2021 (FR) FR2110357

(51) Int. Cl. G01S 7/02; G01S 13/931

(52) U.S. Cl. CPC G01S 7/023; G01S 13/931

(57) ABSTRACT

Method and device for reducing interference affecting radars installed in vehicles based on smart and coordinated selection of radio transmission parameters according to contextual information specific to each radar. The method takes into account the orientation of the radar's line of sight in order to determine the parameters for the transmission of a radio signal by the radar. By associating a set of parameters for the transmission of a radio signal with the radar's orientation, it is ensured that radars installed in vehicles driving in opposite directions, and therefore having opposite orientations, are incapable of selecting, even by chance, sets of radio signal transmission parameters that are identical or have similarities such that the two signals could cause interference.

### FIELD OF THE INVENTION

The field of the invention is that of autonomous vehicles and driving-assist systems.

More precisely, the invention relates to radars installed in vehicles allowing the use of services such as adaptive speed regulation or the detection of emergency braking situations.

### PRIOR ART AND DRAWBACKS THEREOF

The wish of car manufacturers to improve the safety of their vehicles coupled with the development of autonomous vehicles have led to the creation and development of numerous driving-assist techniques.

Among these driving-assist techniques, some, such as adaptive speed regulation, are based on the use of radars installed in the vehicles.

Adaptive speed regulation is based on the conjoint use of a radar and a system for automatic regulation of the speed of the vehicle. Thus the radar measures the distance and speed of approach of a vehicle preceding the vehicle in which it is installed, which makes it possible to automatically adjust the speed of the latter in order to maintain a safety distance to avoid a collision, and then to resume a cruising speed stored in the system when there is no longer an obstacle or a vehicle located within a minimum distance.

This technology is being required to expand over the next years with the rejuvenation of the vehicle fleet.

Despite the increasing implementation of driving-assist techniques based on the use of radars installed in vehicles, the use of the frequency bands allocated to these radars is not regulated. Such a lack of regulations coupled with a rapid increase in the number of vehicles in circulation implementing such driving-assist techniques is increasing the probability of these radars being impacted by interferences generated by other radars. These interferences disturb the measurements made by the radars, which have a direct influence on the safety of the passengers in the vehicles concerned.

Solutions for reducing the effects of these interferences on the signals received by the radars have been developed. The solutions consist, in some cases, in applying a processing to the signal received in order to attenuate the effects thereof, and in other cases consist in completely randomly modifying transmission parameters of the radar.

Such solutions do not make it possible to offer a satisfactory response to this problem of reducing interferences. This is because the solutions based on the application of a processing to the signal received are often complex and require computing power incompatible with reasonable production costs.

The response of the solutions based on a random modification of the transmission parameters of the radar is for its part too random to be satisfactory. In addition, such a solution will be caused to be less and less satisfactory as the use of radars increases.

There is therefore a need for a technique for reducing interferences impacting a radar installed in a vehicle not having all or some of the aforementioned drawbacks.

### DESCRIPTION OF THE INVENTION

The invention responds to this need by proposing a method for reducing interferences impacting radars installed in vehicles based on a smart coordinated selection of radio signal transmission parameters according to contextual information particular to each radar.

Such a method is particular in that it comprises:
a step of determining an orientation of a line of sight of the radar, a plurality of sets of transmission parameters of a radio signal being associated with a corresponding plurality of orientations of a line of sight of the radar,
a step of selecting, from the plurality of sets of radio signal transmission parameters, the set of transmission parameters of a radio signal corresponding to said orientation of the line of sight of the radar determined,
a step of transmitting the radio signal in accordance with the set of transmission parameters selected.

The solution proposed by the inventors proposes to take into account the orientation of the line of sight of the radar, or by simplification the orientation of the radar, and therefore implicitly of the vehicle, to determine the parameters of transmission of a radio signal by the radar. Thus, since such a solution is applied to the signal to be transmitted, it does not require great computing power.

By associating a set of transmission parameters of a radio signal with an orientation of the radar, it is ensured that radars installed in vehicles travelling in opposite directions, and therefore having opposite orientations (one vehicle travelling towards the east and the other towards the west for example), are unable to select, even fortuitously, sets of radio signal transmission parameters that are identical or have similarities such that the two signals could generate interferences.

Consequently the signal transmitted by the radar of a current vehicle is constructed by means of transmission parameters that do not interfere, or interfere only a little, with a competing radar signal transmitted by another vehicle moving in an orientation different from that of the current vehicle.

The orientation of the line of sight of the vehicle is determined for example by means of a navigation system.

Such a navigation system is for example a GPS (Global Positioning System) or Galileo module, or a compass, installed in the vehicle.

The orientation of the radar can be given in the form of a cardinal direction, for example north, north-west, etc., or in the form of an angle measurement.

In a first example, the plurality of radio signals defined by said sets of transmission parameters are orthogonal to each other.

Using orthogonal radio signals makes it possible to avoid the generation of interferences. Thus, when the signals transmitted by the various radars are orthogonal to each other, it is ensured that each radar receives only the echoes of the radio signal that it has transmitted and that these echoes are not disturbed by interferences generated by a radio signal transmitted by another radar.

In a second example, a set of transmission parameters of a radio signal is distinguished from the other sets of radio signal transmission parameters belonging to the plurality of sets of radio signal transmission parameters by a value of at least one of the parameters constituting the set of parameters.

In this second example, the radio signals transmitted by the radars are not necessarily orthogonal. However, the fact that these radio signals are transmitted in accordance with different sets of transmission parameters helps to reduce the impact of the interferences generated by other radars disturbing the reception of the echoes.

More particularly, the step of selecting said set of transmission parameters furthermore comprises:
a step of identifying a first set of transmission parameters corresponding to said orientation of the line of sight of the radar determined,
a step of selecting said set of transmission parameters from a subset of sets of transmission parameters comprising said first set of transmission parameters.

Allowing, for an orientation of the line of sight of the radar, the choice between a plurality of sets of radio signal transmission parameters, helps to reduce the impact of the interferences. This is because, in such an example, the probability of two vehicles travelling in the same direction selecting transmission parameters of an identical radio signal or having similarities such that the two signals could generate interferences is reduced.

Cleverly, the sets of transmission parameters constituting said subset are identified by means of a window centred on the first set of transmission parameters, said window comprising at least one second set of transmission parameters preceding the first set of transmission parameters among the plurality of sets of transmission parameters and at least one third set of transmission parameters following the first set of transmission parameters among the plurality of sets of transmission parameters.

The size of the window is a compromise between the number of sets of transmission parameters between which the radar can select and the proportion in which it is wished to limit the risk of interferences.

The plurality of sets of transmission parameters of a radio signal being ordered since each set of transmission parameters is associated with a range of orientations of the line of sight of a given radar, it can be ordered by increasing orientation value or by decreasing orientation value.

This facilitates navigation in all the sets of transmission parameters during a selection step.

The various transmission parameters of a radio signal constituting a set of transmission parameters belong to the group comprising among other things:
a carrier frequency of the radio signal,
an amplitude of the radio signal,
a phase of the radio signal,
a polarisation of the radio signal,
a transmission power of the radio signal,
a coding to be applied to the radio signal prior to transmission thereof,
a periodicity of the radio signal,
an instant of transmission of the radio signal,
a duration of transmission of the radio signal.

Such a list of transmission parameters is not exhaustive. A set of radio signal transmission parameters can comprise all or only some of the parameters listed above.

When two orientations are close, e.g. north and north-west, the two subsets corresponding respectively to each can have common sets of transmission parameters. The radars the lines of sight of which point in these two directions in fact run little risk of being impacted by each other.

Finally, in a last example, the method comprises, prior to the selection step, a step of receiving information on synchronisation of the radars with each other, said set of radio signal transmission parameters then being selected according to the orientation of the line of sight of the radar determined and the synchronisation information received.

Taking the synchronisation information into account makes it possible to act on the instants of transmission of the radio signals by the radars. This makes it possible to reduce the number of sets of radio signal transmission parameters proposed since it suffices simply to act on the value of the instant of transmission of the radio signal to reduce the interferences.

Another object of the invention is a device adapted to reduce interferences impacting radars installed in vehicles comprising at least one processor configured to
determine an orientation of a line of sight of the radar, a plurality of sets of transmission parameters of a radio signal being associated with a corresponding plurality of orientations of a line of sight of the radar, the processor furthermore being configured to:
select, from the plurality of sets of radio signal transmission parameters, the set of transmission parameters of a radio signal corresponding to said orientation of the line of sight of the radar determined,
transmit the radio signal in accordance with the set of transmission parameters selected.

The invention also relates to a radar comprising at least one device adapted to reduce interferences impacting radars installed in vehicles such as the one described above.

Finally, the invention relates to a computer program product comprising program code instructions for implementing a method as described previously, when it is executed by a processor.

The invention also relates to a recording medium that can be read by a computer on which a computer program is stored comprising program code instructions for executing the steps of the method according to the invention as described above.

Such a recording medium may be any entity or device capable of storing the program. For example, the medium may include a storage means, such as a ROM, for example a CD-ROM or a microelectronic circuit ROM, or a magnetic recording means, for example a USB key or a hard disk.

Moreover, such a recording medium may be a transmissible medium such as an electrical or optical signal, which can be routed via an electrical or optical cable, by radio or by other means, so that the computer program that it contains is executable remotely. The program according to the invention can in particular be downloaded on a network, for example the internet.

Alternatively, the recording medium may be an integrated circuit in which the program is incorporated, the circuit being adapted to implement or to be used in the implementation of the method that is the aforementioned object of the invention.

### LIST OF FIGURES

Other aims, features and advantages of the invention will emerge more clearly from the reading of the following description, given by way of simple illustrative and non-limitative example, in relation to the figures, among which:

FIG. 1A: this figure shows a first situation wherein a radar installed in a current vehicle can be impacted by interferences generated by one or more radars installed in other vehicles;

FIG. 1B: this figure shows a second situation wherein a radar installed in a current vehicle can be impacted by interferences generated by one or more radars installed in other vehicles;

FIG. 2: this figure shows the various steps of a method for transmitting a radio signal implemented by a radar installed in a vehicle in accordance with at least one embodiment of the present solution;

FIG. 3: this figure shows several examples of radio signals that can be generated from various sets of transmission parameters;

FIG. 4A: this figure shows an example of an assembly of sets of transmission parameters;

FIG. 4B: this figure shows another example of an assembly of sets of transmission parameters;

FIG. 5 this figure shows a working cycle of a radar consisting of a transmission cycle and a reception cycle;

FIG. 6: this figure shows the increase in the mean noise level perceived by radars when a travel of 100 vehicles on a motorway is simulated;

FIG. 7: this figure shows a radar able to implement certain steps of the present solution.

### DETAILED DESCRIPTION OF EMBODIMENTS OF THE INVENTION

The general principle of the solution for reducing interferences impacting a radar installed in a vehicle proposed by the inventors is based on a smart coordinated selection of radio signal transmission parameters according to contextual information particular to each radar.

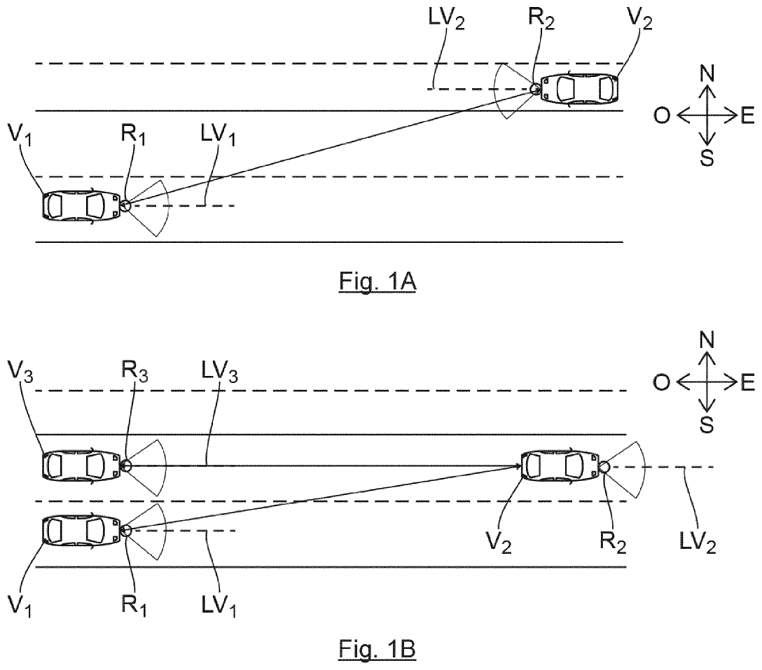

Two main situations wherein a radar installed in a current vehicle can be impacted by interferences generated by one or more radars installed in other vehicles are now presented in relation to FIG. 1A and FIG. 1B.

FIG. 1A shows a first vehicle V₁ incorporating a radar R₁ and a second vehicle V₂ incorporating a radar R₂. In the situation shown in FIG. 1A, the first vehicle V₁ is moving from west to east, and the second vehicle V₂ is moving from east to west. The line of sight LV₁ of the radar R₁ installed in the first vehicle V₁ and the line of sight LV₂ of the radar R₂ installed in the second vehicle V₂ are both parallel to the east-west axis but do not have the same direction. This is because, just like the vehicle V₁, the line of sight LV₁ of the radar R₁ points towards the east, whereas the line of sight LV₂ of the radar R₂ points towards the west since the vehicle V₂ is travelling towards the west.

When, as on FIG. 1A, the vehicle V₁ and the vehicle V₂ are moving towards each other, then the radar V₁ is located in the line of sight LV₂ of the radar R₂ and vice versa. In such a case, the power P_{received} of a radio signal received by the radar R₁ is expressed as follows:

$${P}_{r eceiνed} = \frac{{P}_{transmitted} \times G}{4 π {R}^{2}} x {A}_{ω}$$

with P_{transmitted} the power of the radio signal transmitted by the radar R₂ causing interferences at the radar R₁, G the gain of the antenna of the radar R₁, R the distance separating the radars R₁ and R₂, and Aω, the effective cross section of the radar R₁.

FIG. 1B also shows the first vehicle V₁ incorporating the radar R₂, the second vehicle V₂ incorporating the radar R₂ and a third vehicle V₃ incorporating a radar R₃. In the situation shown in FIG. 1B, the vehicles V₁, V₂, V₃ are all moving from west to east. Likewise the lines of sight LV₁ of the radar R₁ installed in the first vehicle V₁, LV₂ of the radar R₂ installed in the second vehicle V₂, and LV₃ of the radar R₃ installed in the third vehicle V₃, all point towards the east. In such a case, the radars R₁, R₂ and R₃ should not suffer interferences. However, the vehicle V₃ being located at a sufficiently short distance from the vehicle V₂, part of the radio signal transmitted by the radar R₃ is reflected by the vehicle V₂. The radio signal thus reflected may generate interferences impacting the radar R₁ when the vehicle V₁ is also located at a sufficiently short distance from the vehicle V₂. Objects other than a vehicle may constitute obstacles on which a radio signal transmitted by a radar is reflected; it may be a case of street furniture, buildings, non-motorised vehicles, etc.

In such circumstances, the power P′_{received} of a radio signal reflected by the radar R₁ is expressed as follows:

$${P}_{receiνed}^{′} = \frac{{P}_{transmitted}^{′} \times G \times σ}{16 {n}^{2} {R}^{4}} x {A}_{ω}$$

with P′_{transmitted} the power of the reflected radio signal causing interferences at the radar R₁, G the gain of the antenna of the radar R₁, R the distance separating the radar R₁ from the obstacle on which the radio signal transmitted by the radar R₃ is reflected (here the rear of the vehicle V₂, σ the effective cross section of the obstacle and Aω, the effective cross section of the radar R₁.

As mentioned above, in order to reduce the impact of the interferences on the operation of a radar installed in a vehicle, the inventors of the present solution propose regulating the use of the frequency bands used by the radars for transmitting radio signals. Such regulation is based on a smart coordinated selection of radio signal transmission parameters according to contextual information particular to each radar.

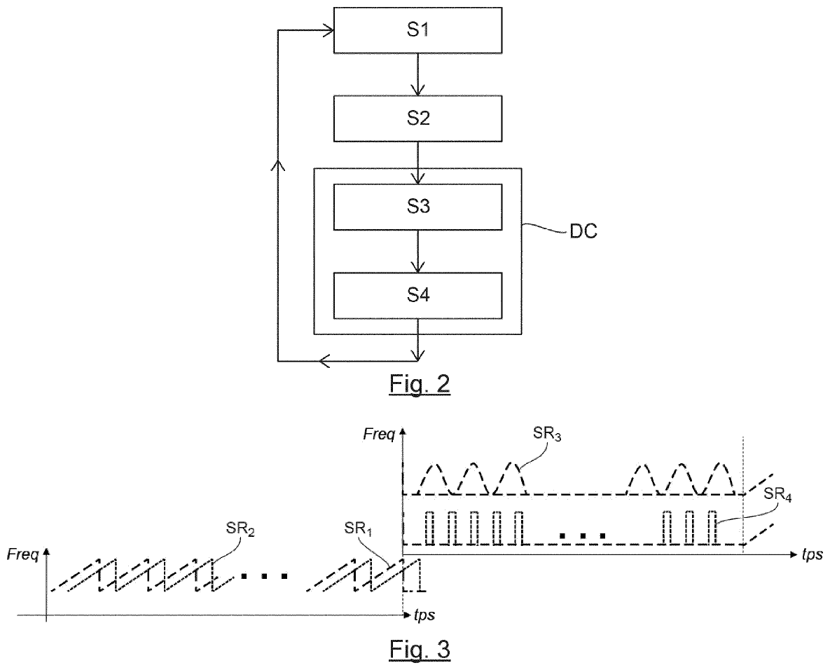

The various steps of a method for transmitting a radio signal implemented by a radar installed in a vehicle in accordance with at least one embodiment of such a solution are described with reference to FIG. 2. By way of example in the following description, the transmission method is implemented by the radar R₁. Naturally, the radars R₂ and R₃ can also implement this transmission method at their level.

The transmission method begins with the implementation of a step S1 during which an orientation of the line of sight LV₁ of the radar R₁ is determined. Implementation of this step E1 is for example triggered when the driver of the vehicle V₁ uses a driving-assist solution such as adaptive speed regulation.

The orientation of the line of sight LV₁ of the radar R₁, which here points towards the east as described with reference to FIG. 1, can be determined in various ways. Thus, in a first example, the orientation of the line of sight LV₁ of the radar R₁ is obtained by means of a GPS module installed in the vehicle V₁.

In another example, the vehicle incorporates cellular communication means and is attached to a base station of the eNodeB type when the base station is in accordance with the 4G standards (standing for 4th generation of standards for mobile telephony) or of the gNb type when the base station is in accordance with the 5G standards (standing for 5th generation of standards for mobile telephony). It is then possible to determine the orientation of the line of sight LV₁ of the radar R₁ by means of measurements made by the base station.

In another example, the orientation of the line of sight LV₁ of the radar R₁ is obtained by means of a compass installed in the vehicle V₁. Naturally, methods other than those listed above making it possible to determine the orientation of the line of sight LV₁ can be envisaged.

Once the orientation of the line of sight LV₁ of the radar R₁ has been determined, a set of transmission parameters ParSetⱼ of a radio signal intended to be used by the radar R₁ is selected during a step S2.

The various transmission parameters of a radio signal constituting the set of transmission parameters ParSetⱼ belong to the group comprising, among other things: a carrier frequency of the radio signal, an amplitude of the radio signal, a phase of the radio signal, a polarisation of the radio signal, a transmission power of the radio signal, a coding to be applied to the radio signal prior to transmission thereof, a periodicity of the radio signal, an instant of transmission of the radio signal, a duration of transmission of the radio signal, etc.

Such a set of transmission parameters ParSetⱼ is selected from a plurality of sets of transmission parameters ParSetᵢ where i is a natural integer with i∈(1, . . . , j, . . . , K) grouped in an assembly E of sets of transmission parameters.

The sets of transmission parameters ParSetⱼ belonging to one and the same assembly E of sets of transmission parameters differ from each other by a value of at least one of the parameters constituting them. By differentiating the sets of transmission parameters ParSetⱼ from each other by acting on the value of one or more parameters constituting them, the risk of interferences generated by a radar installed in a first vehicle on a second radar installed in a second vehicle is thereby reduced.

FIG. 3 shows several examples of radio signals SR₁-SR₄ that can be generated from various sets of transmission parameters ParSetⱼ. With reference to FIG. 3; the radio signals SR₁ and SR₂ are sawtooth signals generated from respectively a first set of transmission parameters ParSet₁ and a second set of transmission parameters ParSet₂ that differ from each other by the value of an instant of transmission of the radio signal. A set of transmission parameters ParSet₃ generates for example a radio signal SR₃ of the sinusoidal type, and finally a set of transmission parameters ParSet₄ for its part generates a square-wave radio signal SR₄. Naturally, other forms of radio signal can be generated on the basis of other sets of transmission parameters ParSetⱼ.

In an example of implementation, the values of the various parameters constituting the sets of transmission parameters ParSetⱼ are selected so that the sets of transmission parameters ParSetⱼ make it possible to generate orthogonal radio signals. Such orthogonal radio signals do not interfere with each other.

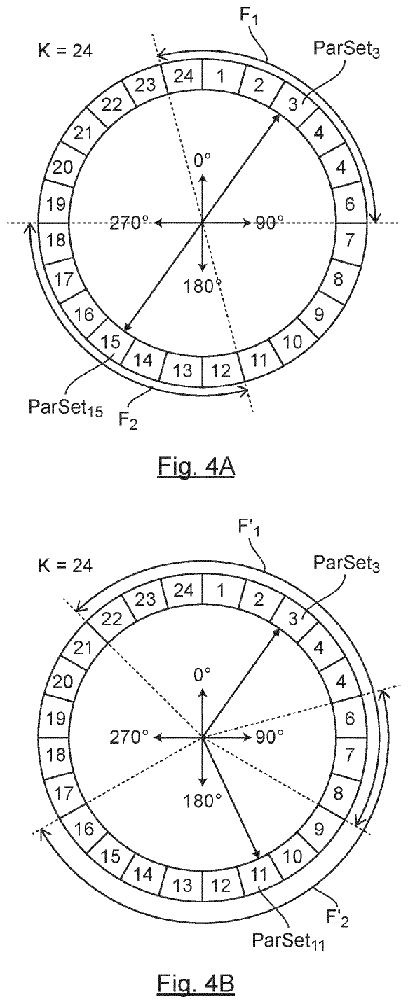

An example of an assembly E of sets of transmission parameters ParSetᵢ is shown in FIG. 4A and in FIG. 4B. On this figure, each set of transmission parameters ParSetᵢ constituting the assembly E is represented by an index k ∈(1, . . . , j, . . . , K), here K=24, and is associated with a given orientation range, e.g. [0-15°], [15-30°], etc. The width of the orientation ranges associated with each set of transmission parameters is given by 360/24. More generally, an orientation range has a width of 360/K°.

Such an assembly E of sets of transmission parameters ParSetⱼ is an ordered assembly in which the various sets of transmission parameters ParSetⱼ are sorted so as to allow a clever selection of a set of transmission parameters by the various radars that have access to this assembly E. Thus, in one example, the sets of transmission parameters ParSetᵢ are sorted by increasing orientation ranges, i.e. the first set of transmission parameters ParSet₁ is associated with the orientation range [0-15°], then the second set of transmission parameters ParSet₂ is associated with the orientation range [15-30°], etc. In another example, the sets of transmission parameters ParSetᵢ are sorted by decreasing orientation ranges, i.e. the first set of transmission parameters ParSet₁ is associated with the orientation range [360-345°], then the second set of transmission parameters ParSet₂ is associated with the orientation range [345-330°], etc.

In one example, the value of the angle representing the orientation of the line of sight LV₁ of the radar R₁ determined during step E1 is measured in a reference frame common to all the vehicles V₁-V₃. Such a reference frame can be defined as follows: the cardinal north indicates the value 0°; the east=the value 90°; the south the value 180° and the west the value 270°.

In another example, the reference frame in which the value of the angle representing the orientation of the line of sight LV₁ of the radar R₁ determined during step E1 is measured in a reference frame centred on the vehicle V₁ or V₂ or V₃. Such a reference frame can be defined as follows: the front of the vehicle indicates the value 0°; the right of the vehicle indicates the value 90°; the rear of the vehicle indicates the value 180° and the left of the vehicle indicates the value 270°. In such an example, the orientation of the vehicle is communicated to the surrounding vehicles for example via a base station to which the vehicles are attached by means of the cellular communication module.

In one example, it is possible to distribute the sets of transmission parameters ParSetⱼ in the assembly E randomly when these sets of transmission parameters ParSetⱼ allow the generation of orthogonal radio signals since the orthogonality of the radio signals thus generated reduces interferences. Consequently, in such a case, the sequencing of the sets of transmission parameters ParSetⱼ in the assembly E is of little importance.

In another example, the various sets of transmission parameters ParSetⱼ are distributed in the assembly E according to a defined scheme. Thus, for example, heterogeneous sets of transmission parameters ParSetⱼ, i.e. sets of transmission parameters for which the values of all or some of the transmission parameters are such that the radio signals generated from these sets of transmission parameters ParSetⱼ interfere little with each other, can be associated with orientation ranges distant from each other, such as an orientation range [0-15°] and an orientation range [90-105° ]. Thus the various radars transmitting these radio signals suffer little interference and operate correctly. This is because such a distribution of the sets of transmission parameters ParSetj in the assembly E reduces the probability of two vehicles V₁ and V₂ travelling in opposite directions, as shown in FIG. 1A, selecting identical transmission parameters or ones having similarities such that a radio signal transmitted by the radar R₂ could cause interferences at the radar R₁.

Such a distribution of the sets of transmission parameters ParSetⱼ in the assembly E also reduces the probability of two vehicles V₁ and V₃ travelling in opposite directions, as shown in FIG. 1B, selecting identical transmission parameters of a radio signal or ones having similarities such that a radio signal transmitted by the radar R₃ could cause, at the radar R₁, interferences caused by the reflection of the radio signal thus transmitted on any obstacle, here the vehicle V₂.

In order to further reduce the probability of two vehicles selecting identical transmission parameters, the vehicles can communicate with each other, in particular via the “Vehicle-to-All” communication network, also referred to as V2X. Each vehicle can thus communicate the set of parameters that it has selected so that the other vehicles receive this information and withdraw the sets of parameters already used from the assembly E. To further improve this prediction of the sets of parameters already used, the vehicles can also communicate, via the V2X system, the orientation of their radar in addition to the set of parameters used. Thus a vehicle withdraws the sets of parameters received from vehicles the radars of which have orientations liable to cause interferences.

The method for predicting the sets of parameters used thus comprises:
a step of sending, preferably via the V2X communication system, by a first vehicle, information relating to its radar: this information comprising the set of parameters used by its radar and/or the orientation of said radar, and
a step of reception of said information by a second vehicle,
a step of withdrawing said set of parameters from the assembly E.

Optionally, the method can comprise a step of comparing, by the second vehicle, the orientation of the radar received from the first vehicle with the orientation of the radar of the first vehicle, the set of parameters being withdrawn from the assembly E if the orientations are identical or similar.

In one example, the assembly E of sets of transmission parameters ParSetⱼ is stored in the various radars R₁-R₃ installed in a vehicle V₁-V₃. For example, all the vehicles of the same manufacturer use the same assembly E of sets of transmission parameters ParSetj.

In another example, the vehicles V₁-V₃ being connected vehicles, such as autonomous vehicles, the base station to which they are attached via their cellular communication means regularly transmits data relating to the assembly E of sets of transmission parameters ParSetⱼ from which the radar can select a set of transmission parameters ParSetᵢ to use. These data relating to the assembly E can be all the sets of transmission parameters ParSetⱼ, an index of the set of parameters to be selected from the assembly E when the assembly E is stored in the radar, or the set of transmission parameters ParSetᵢ itself. Such data are transmitted by the base station among the synchronisation information.

With reference to FIGS. 4A and 4B, a first set of transmission parameters ParSet₃ is identified according to the orientation of the line of sight of the radar in question. This first set of transmission parameters ParSet₃ is identified by the radar itself or by the base station.

This is because, according to the orientation of its line of sight, a radar can select, or have attributed to it by the base station, randomly or not, a set of transmission parameters ParSetᵢ included in a first window F₁ centred on the first set of transmission parameters ParSet₃ and comprising, in the example in FIG. 4A, seven sets of transmission parameters: three sets of transmission parameters located before the first set of transmission parameters ParSet₃ in the assembly E and three sets of transmission parameters located after the first set of transmission parameters ParSet₃. The size of the window F₁, here seven, is determined for example by the manufacturer of the radar and is supplied to the radar or to the base station at the same time as the data relating to the assembly E of sets of transmission parameters.

In the example in FIG. 4B, a first window F′₁ centred on the first set of transmission parameters ParSet₃ for its part comprises eleven sets of transmission parameters: five sets of transmission parameters located before the first set of transmission parameters ParSet₃ in the assembly E and five sets of transmission parameters located after the first set of transmission parameters ParSet₃.

Once the set of transmission parameters ParSetᵢ has been selected from these seven (or these eleven) possible sets of transmission parameters, the radar R₁ transmits a radio signal SR generated in accordance with the values of the parameters constituting the set of transmission parameters ParSetᵢ and captures surrounding radio signals during a step S3. The radio signal SR is transmitted during a transmission/reception cycle ERC with a given duration referred to as transmission duration DER.

According to an alternative embodiment, an orientation range is defined around the orientation of the line of sight in order to form a parameter-set window The orientation range is thus defined from the orientation of the line of sight and from an angular margin 3 around the orientation of the line of sight. The size of the window can be adapted by modifying the angular margin 3, in particular to adapt to the number of vehicles present in the vicinity. Thus, in the case of dense traffic and therefore a large number of cars, the angular margin 3 is increased in order to increase the window and thus increase the number of sets of parameters that can be selected, which reduces the risk of interference. In the case of light traffic, the number of vehicles and therefore the risk of mitigation are low, and the angular margin 3 is then decreased in order to reduce the window. As in the case of the prediction method, the vehicles can communicate with each other, in particular via the V2X system, in order to determine the density of the traffic and more particularly the density of radar having a similar orientation.

Preferably, the angular margin β is at least equal to the distance between two sets of parameters in order to integrate at least one second set of parameters in the window.

In a step S4, once the transmission/reception duration DER has elapsed, the radar R₁ switches into data-processing mode for a given duration referred to as the processing duration DT. During this processing cycle TC, the radar R₁ processes the radio signals that it captured during the transmission/reception cycle ERC in order to determine whether it is a case of echoes of the radio signal SR that it transmitted or of radio signals that it can ignore.

In one example, step S4 but also steps S1 and S2 can be implemented during a processing cycle TC. Thus, once the processing duration DT has elapsed, not only has the radar R₁ processed the radio signals captured during step S3 but has also determined a new value of the orientation of its line of sight LV₁ and has selected a new set of transmission parameters in prediction of a new occurrence of step S3.

A working cycle DC of a radar consists of a transmission/reception cycle ERC and a processing cycle TC. Such a working cycle DC is shown in FIG. 5. The transmission/reception cycle ERC during which a radio signal SR₁ is transmitted by the radar, and then a processing cycle TC during which no radio signal is sent, can be seen on this figure. During the transmission/reception cycle RC, the radar R₁ also captures radio signals and, during the processing cycle TC, determines whether it is a case of the echoes of the radio signal SR₁ that it transmitted during the transmission/reception cycle ERC. If such is the case, the radar R₁ then processes these echoes in a conventional manner.

A working cycle DC corresponds in a first example to the steps S3 and S4 of the present method. In the end of each working cycle DC, steps S1 and S2 are implemented. Thus, before each working cycle DC, the orientation of the line of sight of the radar R₁ is determined once again and a new set of transmission parameters ParSetₖ is selected either in the same subset or in another subset according to the new value of the orientation of the line of sight LV₁ of the radar R₁. The risk of the radar R₁ being impacted by interferences generated by other radars R₂, R₃ is then reduced.

In a second example, steps S1 and S2 can be implemented during the processing cycle TC of a working cycle DC.

Thus, once again with reference to FIG. 4A, during the implementation of a new working cycle DC, a second set of transmission parameters ParSet₁₅ is identified according to the new value of the orientation of the line of sight of the radar in question determined during a new occurrence of step S1.

The radar then selects, or has attributed to it by the base station, a new set of transmission parameters ParSetₖ in a second window F₂ centred on the second set of transmission parameters ParSet₁₅ comprising seven sets of transmission parameters: three sets of transmission parameters located before the second set of transmission parameters ParSet₁₅ in the assembly E and three sets of transmission parameters located after the second set of transmission parameters ParSet₁₅.

In the example of FIG. 4B, during the execution of a new working cycle DC, the second set of transmission parameters ParSet₁₅ is identified according to the new value of the orientation of the line of sight of the radar in question determined during a new occurrence of step S1.

The radar then selects, or has attributed to it by the base station, a new set of transmission parameters ParSetₖ in a second window F₂ centred on the second set of transmission parameters ParSet₁₅ comprising eleven sets of transmission parameters: seven sets of transmission parameters located before the second set of transmission parameters ParSet₁₅ in the assembly E and seven sets of transmission parameters located after the second set of transmission parameters ParSet₁₅. In this example, it can be seen that the windows F′₁ and F′₂ overlap despite the significant difference existing between the value of the first orientation and the value of the second orientation of the radar. This relates to the fact that the windows F′₁ and F′₂ have a significant width.

Once the set of transmission parameters ParSetᵢ has been selected from these seven (or these eleven) possible sets of transmission parameters, the radar R₁ transmits a radio signal SR generated in accordance with the values of the parameters constituting the set of transmission parameters ParSetᵢ during a step S3.

In one example, each radar R₁-R₃ has its own internal clock and decides on the timetable of transmission of the video signal that corresponds to the timetable of start of the first working cycle DC.

In another example, the internal clocks of the various radars R₁-R₃ are synchronised with each other, for example by means of the synchronisation information transmitted by a base station to which the vehicles V₁-V₃ n which the radars R₁-R₃ are installed are attached by means of their cellular communication module.

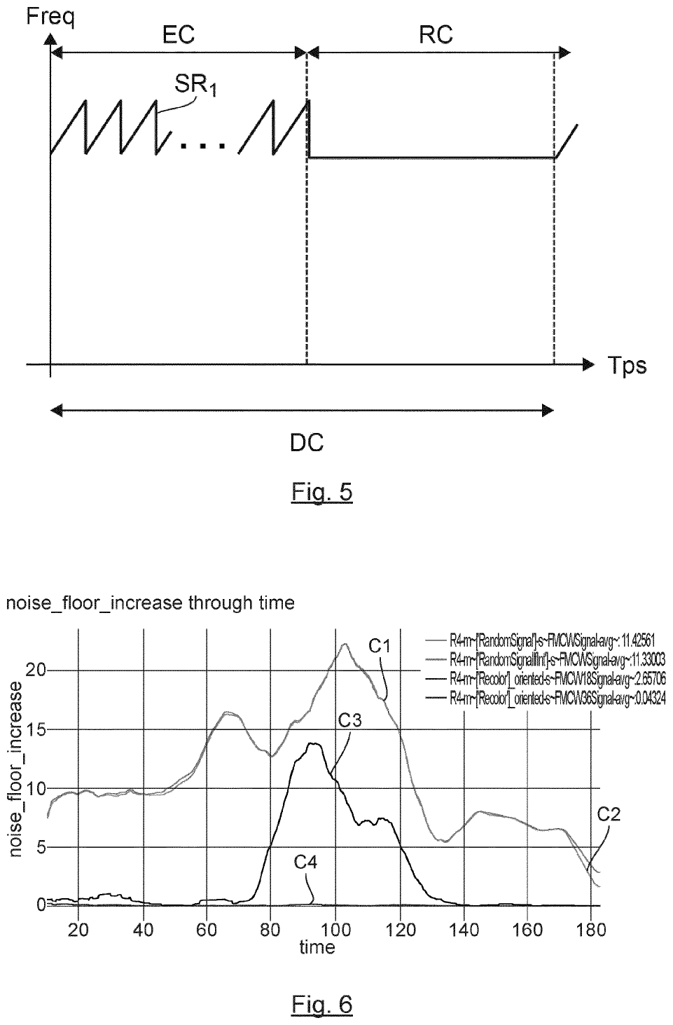

As already mentioned, during the transmission/reception phase ERC of each working cycle DC, the radar R₁ is particularly sensitive to any interferences that may be generated by the various radio signals transmitted by the radars R₂ and R₃. It is there that the benefit of the present solution appears. This is because, by restricting the choice of the sets of transmission parameters ParSetⱼ available according to the orientation of the line of sight, it is possible to reduce the impact on the radar R₁ of the interferences generated by the other radars R₂ and R₃, as can be seen on FIG. 6.

This figure shows the increase in the mean noise level perceived by radars when a travel of 100 vehicles on a motorway is simulated. The curves C1 and C2 represent the results obtained with conventional interference reduction solutions and the curves C3 and C4 represent the results obtained with the method described in the present document. The curve C3 corresponds to an implementation wherein the assembly E comprises 18 sets of heterogeneous transmission parameters ParSetⱼ. The curve C4 corresponds to an implementation wherein the assembly E comprises 36 sets of heterogeneous transmission parameters ParSetⱼ.

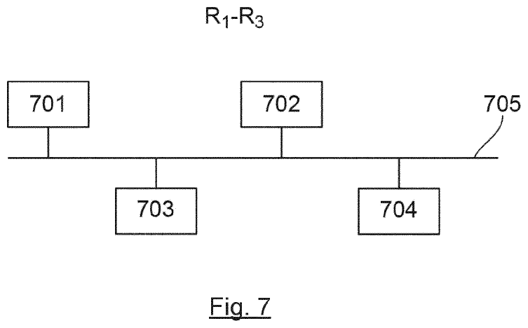

FIG. 7 shows a radar R₁-R₃ able to implement certain steps of the previously described solution.

A radar R₁-R₃ can comprise at least one hardware processor 701, a storage unit 702, a first interface 703, and at least one second network interface 704, which are connected together through a bus 705. Naturally, the elements constituting the radar R₁-R₃ can be connected by means of a connection other than a bus.

The processor 701 controls the operations of the radar R₁-R₃. The storage unit 702 stores at least one program for implementing the method that is the object of the invention to be executed by the processor 701, and various data, such as parameters used for calculations made by the processor 701, intermediate data of calculations made by the processor 701, etc. The processor 701 can be formed by any known suitable hardware or software, or by a combination of hardware and software. For example, the processor 701 can be formed by dedicated hardware such as a processing circuit, or by a programmable processing unit such as a central processing unit that executes a program stored in a memory thereof.

The storage unit 702 can be formed by any suitable means capable of storing the program or programs and data in a manner that can be read by a computer. Examples of storage unit 702 comprise non-transient storage media that can be read by computer such as semiconductor memory devices, and magnetic, optical or magnetooptical recording media loaded in a read and write unit.

The interface 703 consists of means for transmitting and receiving radio signals such as an antenna. Such an interface 703 is connected to a radio signal transmission chain and to a chain for processing received radio signals, neither shown on the figure.

The network interface 704 for its part provides a connection between the radar R₁-R₃ and at least one base station. It may be the network interface 704 of the cellular communication module previously mentioned.

1. A method for transmitting a radio signal by a radar installed in a vehicle, comprising:
determining an orientation of a line of sight of the radar, a plurality of sets of transmission parameters of the radio signal being associated with a corresponding plurality of orientations of the line of sight of the radar;
selecting, from the plurality of sets of radio signal transmission parameters, the set of transmission parameters of the radio signal corresponding to said orientation of the line of sight of the radar determined-; and
transmitting the radio signal in accordance with the set of transmission parameters selected.

2. The method for transmitting a radio signal according to claim 1, wherein the orientation of the line of sight of the vehicle is determined by using a navigation system.

3. The method for transmitting a radio signal according to claim 1, wherein the plurality of radio signals defined by said sets of transmission parameters are orthogonal to each other.

4. The method for transmitting a radio signal according to claim 1, wherein a set of the transmission parameters of the radio signal is distinguished from other sets of transmission parameters belonging to the plurality of sets of transmission parameters by a value of at least one of the parameters constituting the set of parameters.

5. The method for transmitting a radio signal according to claim 1, wherein selecting said set of transmission parameters furthermore comprises:
identifying a first set of the transmission parameters corresponding to said orientation of the line of sight of the radar determined,
selecting said set of transmission parameters from a subset of sets of transmission parameters comprising said first set of transmission parameters.

6. The method for transmitting a radio signal according to claim 5, wherein the sets of transmission parameters constituting said subset are identified by using a window centred on the first set of transmission parameters, said window comprising at least one second set of transmission parameters preceding the first set of transmission parameters among the plurality of sets of transmission parameters and at least one third set of transmission parameters following the first set of transmission parameters among the plurality of sets of transmission parameters.

7. The method for transmitting a radio signal according to claim 6, wherein the plurality of sets of transmission parameters of the radio signal is ordered by increasing orientation value.

8. The method for transmitting a radio signal according to claim 6, wherein the plurality of sets of transmission parameters of the radio signal is ordered by decreasing orientation value.

9. The method for transmitting a radial signal according to claim 1, wherein the transmission parameters of the radio signal constituting a set of transmission parameters belong to the group consisting of:
a carrier frequency of the radio signal,
an amplitude of the radio signal,
a phase of the radio signal,
a polarisation of the radio signal,
a transmission power of the radio signal,
a coding to be applied to the radio signal prior to transmission thereof,
a periodicity of the radio signal,
an instant of transmission of the radio signal,
a duration of transmission of the radio signal.

10. The method for transmitting a radio signal according to claim 1, comprising, prior to the selecting, receiving information on synchronisation of radars with each other, said set of radio signal transmission parameters then being selected according to the orientation of the line of sight of the radar determined and the synchronisation information received.

11. A device adapted to reduce interferences impacting radars installed in vehicles, the device comprising:
at least one processor configured to:
determine an orientation of a line of sight of a radar, a plurality of sets of transmission parameters of a radio signal being associated with a corresponding plurality of orientations of the line of sight of the radar;
select, from the plurality of sets of transmission parameters, the set of transmission parameters of the radio signal corresponding to said orientation of the line of sight of the radar determined; and
transmit the radio signal in accordance with the set of transmission parameters selected.

12. A radar comprising the device adapted to reduce interferences impacting radars installed in vehicles according to claim 11.

13. A non-transitory computer readable medium comprising a computer program product stored thereon comprising program code instructions for implementing a method for reducing interferences impacting radars installed in vehicles, when the instructions are executed by a processor,
wherein the method comprises:
determining an orientation of a line of sight of a radar, a plurality of sets of transmission parameters of a radio signal being associated with a corresponding plurality of orientations of the line of sight of the radar;
selecting, from the plurality of sets of transmission parameters, the set of transmission parameters of the radio signal corresponding to said orientation of the line of sight of the radar determined; and
transmitting the radio signal in accordance with the set of transmission parameters selected.
